(19) United States
(12) Patent Application Publication
(10) Pub. No.: US 2018/0356574 A1
(43) Pub. Date: Dec. 13, 2018

(54) BLUE LIGHT ABSORPTION CUT-OFF FILM AND BLUE LIGHT DISPLAY DEVICE

(71) Applicant: Shenzhen China Star Optoelectronics Technology Co. Ltd., Shenzhen City (CN)

(72) Inventors: Dongze Li, Shenzhen City (CN); Lixuan Chen, Shenzhen City (CN); Hsiaohsien Chen, Shenzhen City (CN); Yungjui Lee, Shenzhen City (CN)

(21) Appl. No.: 15/557,813

(22) PCT Filed: Jul. 13, 2017
(86) PCT No.: PCT/CN2017/092849

§ 371 Date: Sep. 13, 2017

(30) Foreign Application Priority Data
Jun. 13, 2017 (CN) 201710444275.8

(51) Int. Cl. G02B 5/22; G02F 1/1335

(52) U.S. Cl. CPC G02B 5/223; G02F 1/133621; G02F 1/133617; G02F 2001/133614; G02B 2207/101; G02F 2202/36; G02F 1/133514

(57) ABSTRACT

A blue light absorption cut-off film and a blue light display device are provided. The blue light absorption cut-off film of the present disclosure is formed by a photoresist material including a resin, a yellow pigment, a dispersing agent, and a photoinitiator, and thus redundant blue lights in the blue light display device can be effectively absorbed to avoid the overall display effect thereof of tending to be blue. Also, the present disclosure provides a simple manufacturing method. The blue light display device of the present disclosure includes the above blue light absorption cut-off film, thus the redundant blue lights in the blue light display device can be effectively absorbed to avoid the overall display effect thereof of tending to be blue.

### BACKGROUND OF THE INVENTION

### 1. Field of the Invention

The present disclosure relates to a field of display technology, and more specifically to a blue light absorption cut-off film and a blue light display device.

### 2. Description of the Prior Art

With the development of display technology, people's requirements for the display quality of display devices are higher and higher. Quantum dot materials (QD for short) are semiconductor grains having a particle size of 1 nm to 100 nm. A quantum confinement effect is produced since the particle size of the QD is lesser, and is less than or close to the exciton Bohr radius of a corresponding bulk material. The continuous energy-band structure of the bulk material is converted into a discrete energy-level structure. The transition of electrons occurs under the excitation of an external light source to emit a fluorescent light.

The QD has this special discrete energy-level structure, so that the half-wave width of the QD is narrow. Therefore, a high purity monochromatic light can be emitted. The QD has a higher luminous efficiency than traditional displays. In the meantime, different wavelengths of light can be excited by regulating the size of the QD or using QDs with different components since the energy band gap of the QD is influenced greatly by the size thereof. Existing technologies are focused primarily on quantum dot films or quantum dot tubes. Each of the quantum dot films is manufactured by encapsulating quantum dots having light-emitting wavelengths of red light, green light, and blue light into an engineering plastic film. Each of the quantum dot tubes is manufactured by encapsulating quantum dots having light-emitting wavelengths of red light, green light, and blue light into a glass tube. Also, the above structure is sandwiched between a back light and a display system, and then excited by a traditional white back light to achieve a purpose of abundant color gamut. However, whether a QD film structure or a QD tube structure is relatively single for the use means of the quantum dot materials. In the meantime, there are problems of excessive cost and material reliability since the protection and encapsulation of a polyethylene terephthalate (PET) film and a small aperture glass tube, which have high-quality optics, are required.

In a recent application about quantum dots, there is still another alternative in the industry. That is, a quantum dot color filter (QDCF) is manufactured by a quantum dot material. Traditional color filters are replaced by the quantum dot color filter. About the alternative, some progress has already been made by the industry. Currently, the most common approach is that the quantum dot material is doped in the structure of a color filter, that is used with a blue back light, and the color display thereof is realized by using photoluminescence characteristics. For example, in an existing liquid crystal display panel containing the QDCF, the QDCF usually includes red pixel units, green pixel units, and blue pixel units, and the red pixel units, the green pixel units, and the blue pixel units are arranged in an array. In which, the red pixel units and the green pixel units are formed by an ink-jet printing process with a red quantum dot ink material and a green quantum dot ink material, respectively. The red pixel units and the green pixel units respectively emit red light and green light under the excitation of the blue back light. The blue pixel units are formed by a filling of a transparent organic material. A blue light emitted by the blue pixel units is provided by a backlight module which produces a blue back light. A screen cannot be normally displayed to integrally tend to be blue since the blue back light cannot be completely used for exciting the QDCF, and the blue back light which is not utilized can also pass through the red pixel units and the green pixel units.

### SUMMARY OF THE INVENTION

An object of the present disclosure is to provide a blue light absorption cut-off film which is formed by a photoresist material. Redundant blue lights in the blue light display device can be effectively absorbed by the blue light absorption cut-off film to avoid the overall display effect thereof of tending to be blue. Also, the present disclosure provides a simple manufacturing method.

An object of the present disclosure is further to provide a blue light display device including the above blue light absorption cut-off film, and thus the redundant blue lights in the blue light display device can be effectively absorbed to avoid the overall display effect thereof of tending to be blue

To achieve the above object, the present disclosure provides a blue light absorption cut-off film which is formed by a photoresist material. The photoresist material includes a resin, a yellow pigment, a dispersing agent, and a photoinitiator.

In the photoresist material, the yellow pigment is an azo yellow pigment, a naphthol yellow pigment, a benzimidazolone yellow pigment, or an azo condensation yellow pigment.

In the photoresist material, the resin is a methacrylate resin or an epoxy resin.

The present disclosure further provides a blue light display device. The blue light display device includes a blue light source, a photoluminescence color filter disposed on the blue light source, and the above blue light absorption cut-off film disposed on the photoluminescence color filter.

The photoluminescence color filter includes red pixel units, green pixel units, and blue pixel units, and the red pixel units, the green pixel units, and the blue pixel units are arranged in an array.

The blue light absorption cut-off film has openings which are aligned to the blue pixel units.

The photoluminescence color filter is a quantum dot color filter.

The red pixel units and the green pixel units are formed by an ink-jet printing process with a red quantum dot ink material and a green quantum dot ink material, respectively. The blue pixel units are formed by a transparent organic material.

The photoluminescence color filter is a fluorescent dye color filter.

The blue light absorption cut-off film is formed by a patterning process. The blue light absorption cut-off film is used for removing an unconverted blue fluorescent light which is formed by a light emitted by the blue light source irradiating through the red pixel units and the green pixel units.

A method for manufacturing the blue light absorption cut-off film includes the following steps:

step S1: forming a yellow film layer by coating the photoresist material;
step S2: forming a photoresist layer onto the yellow film layer;
step S3: providing a mask, exposing the photoresist layer using the mask, and then developing the exposed photoresist layer to form a photoresist pattern layer; and
step S4: using the photoresist pattern layer as a shielding layer, and etching the yellow film layer to obtain a patterned blue light absorption cut-off film.

The blue light display device is a liquid crystal display device, a micro light emitting diode display device, or an organic light-emitting diode display device.

The present disclosure also provides a blue light display device. The blue light display device includes a blue light source, a photoluminescence color filter disposed on the blue light source, and the above blue light absorption cut-off film disposed on the photoluminescence color filter.

In which, the photoluminescence color filter includes red pixel units, green pixel units, and blue pixel units, and the red pixel units, the green pixel units, and the blue pixel units are arranged in an array.

The blue light absorption cut-off film has openings which are aligned to the blue pixel units.

The photoluminescence color filter is a quantum dot color filter.

The red pixel units and the green pixel units are formed by an ink-jet printing process with a red quantum dot ink material and a green quantum dot ink material, respectively. The blue pixel units are formed by a transparent organic material.

The blue light absorption cut-off film is formed by a patterning process. The blue light absorption cut-off film is used for removing an unconverted blue fluorescent light which is formed by a light emitted by the blue light source irradiating through the red pixel units and the green pixel units.

In which, a method for manufacturing the blue light absorption cut-off film includes the following steps:

step S1: forming a yellow film layer by coating the photoresist material;
step S2: forming a photoresist layer onto the yellow film layer;
step S3: providing a mask, exposing the photoresist layer using the mask, and then developing the exposed photoresist layer to form a photoresist pattern layer; and
step S4: using the photoresist pattern layer as a shielding layer, and etching the yellow film layer to obtain a patterned blue light absorption cut-off film.

The present disclosure has the following beneficial effects. The blue light absorption cut-off film of the present disclosure is formed by the photoresist material including the resin, the yellow pigment, the dispersing agent, and the photoinitiator, thus redundant blue lights in the blue light display device can be effectively absorbed to avoid the overall display effect thereof of tending to be blue. Also, the present disclosure provides a simple manufacturing method. The blue light display device of the present disclosure includes the above blue light absorption cut-off film, thus the redundant blue lights in the blue light display device can be effectively absorbed to avoid the overall display effect thereof of tending to be blue.

### BRIEF DESCRIPTION OF THE DRAWINGS

The technical solution, as well as beneficial advantages, of the present disclosure will be apparent from the following detailed description of an embodiment of the present disclosure, with reference to the attached drawings. In the drawings:

FIG. 1 is a schematic view of a structure of a blue light display device according to the present disclosure;

FIG. 2 is a schematic view of the step S1 of a method according to the present disclosure for manufacturing a blue light absorption cut-off film;

FIG. 3 is a schematic view of the step S2 of the method according to the present disclosure for manufacturing the blue light absorption cut-off film;

FIGS. 4-5 are schematic views of the step S3 of the method according to the present disclosure for manufacturing the blue light absorption cut-off film; and

FIG. 6 is a schematic view of the step S4 of the method according to the present disclosure for manufacturing the blue light absorption cut-off film.

### DETAILED DESCRIPTION OF THE PREFERRED EMBODIMENTS

To further expound the technical solution adopted in the present disclosure and the advantages thereof, a detailed description is given to a preferred embodiment of the present disclosure and the attached drawings.

The present disclosure provides a blue light absorption cut-off film which is formed by a photoresist material. The photoresist material includes a resin, a yellow pigment, a dispersing agent, and a photoinitiator.

Specifically, in the photoresist material, the yellow pigment is an azo yellow pigment (e.g., Hansa Yellow 10G, Benzidine Yellow), a naphthol yellow pigment (e.g., Permanent Yellow), a benzimidazolone yellow pigment (e.g., C.I. Pigment Yellow 154), or an azo condensation yellow pigment (e.g., Cromophtal Yellow 3G).

Specifically, in the photoresist material, the resin is a methacrylate resin or an epoxy resin. That is, the photoresist material is a material formed by adding the yellow pigment, the dispersing agent, the photoinitiator, and the like into the methacrylate resin or the epoxy resin.

The blue light absorption cut-off film of the present disclosure is formed by the photoresist material. The photoresist material includes the resin, the yellow pigment, the dispersing agent, and the photoinitiator. The blue light absorption cut-off film can be used in all blue light display devices which are displayed in color by transiting a blue light to other color lights, such as a liquid crystal display device, a micro light emitting diode (Micro LED) display device, an organic light-emitting diode (OLED) display device, and the like, which are displayed in color by transiting a blue light to other color lights, thus redundant blue lights in the blue light display device can be effectively absorbed to avoid the overall display effect thereof of tending to be blue. Also, the present disclosure provides a simple manufacturing method.

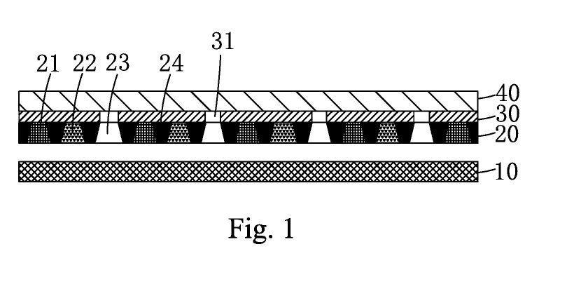

Please refer to FIG. 1, based on the above blue light absorption cut-off film, the present disclosure also provides a blue light display device. The blue light display device includes a blue light source 10, a photoluminescence color filter 20 disposed on the blue light source 10, and the above blue light absorption cut-off film 30 disposed on the photoluminescence color filter 20.

Specifically, the photoluminescence color filter 20 includes red pixel units 21, green pixel units 22, and blue pixel units 23, and the red pixel units 21, the green pixel units 22, and the blue pixel units 23 are arranged in an array. The blue light absorption cut-off film 30 has openings 31 which are aligned to the blue pixel units 23.

Specifically, the photoluminescence color filter 20 can be a quantum dot color filter, and can also be a fluorescent dye color filter formed by a doping of a fluorescent dye or other photoluminescence color filters.

Specifically, the blue light absorption cut-off film 30 is formed by a patterning process. The blue light absorption cut-off film 30 is used for removing an unconverted blue fluorescent light which is formed by a light emitted by the blue light source 10 irradiating through the red pixel units 21 and the green pixel units 22.

Specifically, a method for manufacturing the blue light absorption cut-off film 30 includes the following steps S1-S4.

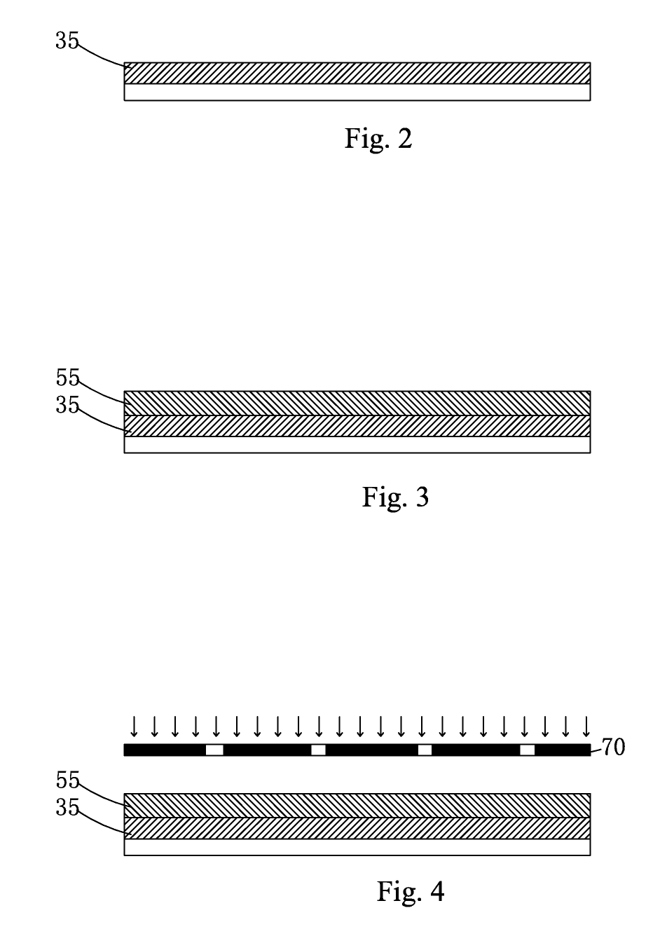

In step S1, as shown in FIG. 2, the photoresist material is provided. The photoresist material is coated to form a yellow film layer 35 which is able to absorb a blue light.

In step S2, as shown in FIG. 3, a photoresist layer 55 is formed on the yellow film layer 35.

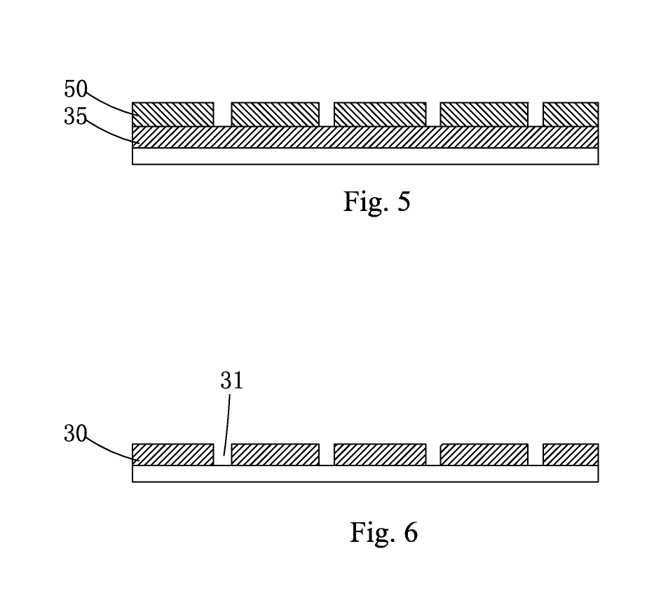

In step S3, as shown in FIGS. 4-5, a mask 70 is provided, and the photoresist layer 55 is exposed by using the mask 70, and then the exposed photoresist layer 55 is developed to form a photoresist pattern layer 50.

In step S4, as shown in FIG. 6, the photoresist pattern layer 50 is used as a shielding layer, and the yellow film layer 35 is etched to obtain a patterned blue light absorption cut-off film 30, thereby completing the manufacture of the blue light absorption cut-off film 30.

Specifically, the blue light display device of the present disclosure can be any one of display devices which are displayed in color by transiting a blue light to other color lights, such as the liquid crystal display device, the micro light emitting diode display device, the organic light-emitting diode display device, and the like, which are displayed in color by transiting a blue light to other color lights. The redundant blue lights in the blue light display device can be effectively absorbed by using the blue light absorption cut-off film 30 in the blue light display device to avoid the overall display effect thereof of tending to be blue.

Specifically, in a preferred embodiment of the blue light display device of the present disclosure, the photoluminescence color filter 20 is a quantum dot color filter. Also, the photoluminescence color filter 20 includes a black pixel spacing layer 24. The black pixel spacing layer 24 separates the red pixel units 21, the green pixel units 22, and the blue pixel units 23. The red pixel units 21 and the green pixel units 22 are formed by an ink-jet printing process with a red quantum dot ink material and a green quantum dot ink material, respectively. The blue pixel units 23 are formed by a transparent organic material. The blue light display device is a liquid crystal display device. Also, the blue light display device includes a color filter substrate 40, an array substrate (not shown in the figures), and a liquid crystal layer (not shown in the figures) sandwiched between the color filter substrate 40 and the array substrate. The color filter substrate 40 and the array substrate are correspondingly arranged and opposite to each other. The blue light absorption cut-off film 30 and the photoluminescence color filter 20 are sequentially disposed on one side of the color filter substrate 40 near the liquid crystal layer. The blue light source 10 is used as a backlight source, and is disposed under the array substrate. The blue light source 10 provides a blue back light for the blue light display device. The blue light source 10 emits the blue back light. The blue back light passes through the array substrate and the liquid crystal layer to irradiate on the photoluminescence color filter 20. Under the excitation of the blue back light, a red quantum dot in the red pixel units 21 in the photoluminescence color filter 20 can emit a red light having a very narrow FWHM (Full width at half maximum). The red light and an unabsorbed blue back light form a mixed light. Then, after the mixed light passes through the blue light absorption cut-off film 30, the blue back light therein is absorbed, and thus a high purity red monochromatic light is obtained to show red. Similarly, after the blue back light passes through the green pixel units 22 and the blue light absorption cut-off film 30, a green monochromatic light is obtained to show green. However, the blue back light is directly passed to show blue since positions corresponding to the blue pixel units 23 are formed by the transparent organic material and the blue light absorption cut-off film 30 is not covered on the blue pixel units 23. Finally, three primary colors (i.e., red, green, and blue) required by color display are provided, and the color display is realized, thus a color gamut index can be effectively increased.

As mentioned above, the blue light absorption cut-off film of the present disclosure is formed by the photoresist material including the resin, the yellow pigment, the dispersing agent, and the photoinitiator, and thus the redundant blue lights in the blue light display device can be effectively absorbed to avoid the overall display effect thereof of tending to be blue. Also, the present disclosure provides a simple manufacturing method. The blue light display device of the present disclosure includes the above blue light absorption cut-off film, thus the redundant blue lights in the blue light display device can be effectively absorbed to avoid the overall display effect thereof of tending to be blue.

Based on the description given above, those having ordinary skills of the art may easily contemplate various changes and modifications of the technical solution and technical ideas of the present disclosure and all these changes and modifications are considered within the protection scope of right for the present disclosure.

What is claimed is:

1. A blue light absorption cut-off film formed by a photoresist material, wherein the photoresist material comprises a resin, a yellow pigment, a dispersing agent, and a photoinitiator.

2. The blue light absorption cut-off film of claim 1, wherein the yellow pigment in the photoresist material is an azo yellow pigment, a naphthol yellow pigment, a benzimidazolone yellow pigment, or an azo condensation yellow pigment.

3. The blue light absorption cut-off film of claim 1, wherein the resin in the photoresist material is a methacrylate resin or an epoxy resin.

4. A blue light display device, comprising a blue light source, a photoluminescence color filter disposed on the blue light source, and the blue light absorption cut-off film of claim 1 which is disposed on the photoluminescence color filter.

5. The blue light display device of claim 4, wherein the photoluminescence color filter comprises red pixel units, green pixel units, and blue pixel units, and the red pixel units, the green pixel units, and the blue pixel units are arranged in an array; the blue light absorption cut-off film has openings which are aligned to the blue pixel units.

6. The blue light display device of claim 5, wherein the photoluminescence color filter is a quantum dot color filter; the red pixel units and the green pixel units are formed by an ink-jet printing process with a red quantum dot ink material and a green quantum dot ink material, respectively; the blue pixel units are formed by a transparent organic material.

7. The blue light display device of claim 5, wherein the photoluminescence color filter is a fluorescent dye color filter.

8. The blue light display device of claim 5, wherein the blue light absorption cut-off film is formed by a patterning process, and the blue light absorption cut-off film is used for removing an unconverted blue fluorescent light which is formed by a light emitted by the blue light source irradiating through the red pixel units and the green pixel units.

9. The blue light display device of claim 8, wherein a method for manufacturing the blue light absorption cut-off film comprises the following steps of:
step S1: forming a yellow film layer by coating the photoresist material;
step S2: forming a photoresist layer onto the yellow film layer;
step S3: providing a mask, exposing the photoresist layer using the mask, and then developing the exposed photoresist layer to form a photoresist pattern layer; and
step S4: using the photoresist pattern layer as a shielding layer, and etching the yellow film layer to obtain a patterned blue light absorption cut-off film.

10. The blue light display device of claim 4, wherein the blue light display device is a liquid crystal display device, a micro light emitting diode display device, or an organic light-emitting diode display device.

11. A blue light display device, comprising a blue light source, a photoluminescence color filter disposed on the blue light source, and the blue light absorption cut-off film of claim 1 which is disposed on the photoluminescence color filter,
wherein the photoluminescence color filter comprises red pixel units, green pixel units, and blue pixel units, and the red pixel units, the green pixel units, and the blue pixel units are arranged in an array,
the blue light absorption cut-off film has openings which are aligned to the blue pixel units,
the photoluminescence color filter is a quantum dot color filter,
the red pixel units and the green pixel units are formed by an ink-jet printing process with a red quantum dot ink material and a green quantum dot ink material, respectively; the blue pixel units are formed by a transparent organic material,
the blue light absorption cut-off film is formed by a patterning process, and the blue light absorption cut-off film is used for removing an unconverted blue fluorescent light which is formed by a light emitted by the blue light source irradiating through the red pixel units and the green pixel units,
a method for manufacturing the blue light absorption cut-off film comprises the following steps of:
step S1: forming a yellow film layer by coating the photoresist material;
step S2: forming a photoresist layer onto the yellow film layer;
step S3: providing a mask, exposing the photoresist layer using the mask, and then developing the exposed photoresist layer to form a photoresist pattern layer; and
step S4: using the photoresist pattern layer as a shielding layer, and etching the yellow film layer to obtain a patterned blue light absorption cut-off film.

12. The blue light display device of claim 11, wherein the blue light display device is a liquid crystal display device, a micro light emitting diode display device, or an organic light-emitting diode display device.
